(19) United States
(12) Patent Application Publication
(10) Pub. No.: US 2009/0173777 A1
(43) Pub. Date: Jul. 9, 2009

(54) System and Method for scoring politicians based on an interactive online political system.

(75) Inventor: Jim Leon Ward, Chesnee, SC (US)

Correspondence Address: JIM WARD, PO BOX 160577, BOILING SPRINGS, SC, 29316, US

(73) Assignee: Jim L. Ward, Boiling Springs, SC (US)

(21) Appl. No.: 11/968,857

(22) Filed: Jan. 3, 2008

(51) Int. Cl. G07C 13/00

(52) U.S. Cl. 235/51

(57) ABSTRACT

The system provides a venue for Internet users to actively participate in the daily legislative process of government and rate individual politician's performance against voting data presented by constituents. The system posts pending legislation, within a political system, to an interactive web site where users vote for or against a piece of legislation and may post opinions. The results are continuously tallied and posted for review according to voting district and political affiliation. After legal votes are placed within the legislative body, a statistical rating is given individual political members according to their voting record against their constituents voting record. The system also provides a method for users to propose legislation and petition signatures for introduction into a political system. Security software, user-input data and codes are used to ensure a one user-one respondent system for data and statistical accuracy.

### CROSS REFERENCE TO RELATED APPLICATIONS

No prior applications. See Information Disclosure Statement for patent search results.

### STATEMENT REGUARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable

### BACKGROUND TO THE INVENTION

1. Field of the Invention

The invention generally employs an apparatus and corresponding methods for performing data processing operations, specifically in a computerized arrangement for the systematic and scientific analysis and evaluation of the members and operation of a legislative organization and collecting and processing of market data in order to predict future demand of a political product and/or service. The invention relates to a system for providing active legislation online for public voting, a method for processing and reporting resulting data allowing analysis of politician's voting records through rankings calculated for each official as well as introducing legislation.

2. Description of the Prior Art

The system of selecting government officials and passing legislation is as wide and varied as any method encompassing any industry on earth. Historically, leadership selection among candidates has ranged from physical and/or mental contests, inheritance, reincarnation, a variety of appointment and election methods, a coupe, assassination and according to Monty Python, “moistened binks tossing scimitars.”

The implementation of law has similarly varied, including seasonal and astrological observations, lottery, dictatorial mandates, numerous legislative processes and a variety of others.

The current state of world affairs hosts a diversity of governing systems encompassing communism, free market communism, socialism, social democracy, democracy, dictatorships, monarchies and others. Each system is itself widely diverse in leadership selection and law development.

In brief, the model of US federal and state democracy has a pooling system of candidates from which political positions are filled by assorted but similar election methods. State and federal legislation is passed by these elected officials through introduction of a bill in a legislative environment, debated, voted on and passed or rejected. If passed it is sent to the executive authority for acceptance or rejection and if accepted becomes law. Once law, it is not immediately scrutinized by the courts, but remains within judicial jurisdiction throughout the life of the law.

Most democracies and socialist systems, some communist hybrids, a few dictatorships and even notable monarchies around the world have systems similar to the United States.

More specifically, politicians in the US democratic system are elected to office through a campaign process. During that process, candidates are selected largely on declared positions held on an array of issues, whether those claims are valid or not. Candidates without prior political history have no voting record. In the prior art, elected officials have a published voting record but that history requires research to locate and interpret and has no baseline in which to compare that record. Some web sites provide excellent information but the mass of information can be overwhelming and the ability to systematically compare against stated positions, constituent positions, or other politicians is non-existent. Each vote must be located on each bill and issue. While this may not be a daunting task for one or two issues, it is extremely time consuming to locate each vote on each bill and research the bill to see which issue it affects and tally those votes against that politician's previously claimed position. Many legislators post a variety of voting records on their web sites, but it may be difficult to locate, seldom complete, often misleading and frequently difficult to decipher.

Active legislation within the United States Senate, House of Representatives, bills before the President and cases for review in the Supreme Court are available online at their respective web sites, the Thomas Registry and/or the Library of Congress. Outside the above methods of record, interested parties may research pending activity at one of those locations but the prior art does not, provide a system for constituents to actively participate in introducing, debating or voting on those activities.

The current election campaign system relies on contributions from the public, organizations, corporations and special interest groups to finance a campaign and is largely independent of government assistance. While the US election process has advantages to the taxpayer, as a financially independent process, it has limitations for the average voter because a common trend is that the candidate with the most money usually wins. In the prior art, this trend directly affects representation in the legislative process, as those who have the greatest ability to contribute are those who receive the greatest benefits of legislation.

The wealthiest campaigns can afford the best political strategists. In the US political environment of today, strategists often determine candidate's positions on issues and not the candidates themselves. Using strategically devised claims of representation and superior financial advertising power, the best funded candidates often get elected into political office over more qualified opponents. In the prior art, politicians most frequently represent positions, policies and legislative efforts of those entities providing the greatest contributions to their campaign, and less often the interests of the individual voter responsible for voting that person into office.

In the prior art, the vast majority of laws are passed in the legislative process without the general publics knowledge. Sometimes riders, which are unpopular, are attached to popular bills and then passed en masse without public knowledge or support. Individual voter's greatest complaint of the US political process is the lack of direct representation. Many feel that once the election is over, politicians no longer feel an obligation to fulfill promises and represent constituents needs. Since there is no system or method of checks and balances on individual politicians in the prior art, politicians have at times failed to fulfill their obligation to the general public. The prior art's informal checks and balances primarily support campaign financier's interests and therefore financier's interests dominate political action.

The greatest reason for this prior art trend is that it is difficult under current political conditions to systematically locate and compare a politician's voting record against their platform claims much less against the wishes of their constituents. Another major factor lies in that politicians voting habits are seldom scrutinized except during a brief time just before election day, which constitutes years worth of records and would require excessive effort for an individual to interpret.

The problems mentioned above are easily blamed on the politician's side of the process. However, another problem confronts the voting public. While the prior art provides methods for individual constituents to inform his or her political Representative of their wishes, those methods can be time consuming and therefore predominately ignored by the general voting population.

The prior art allows for telephone calls, local office visitation, written correspondence and/or e-mail. As phone calls go, common constituents frequently wait on hold for extended periods, the call may be passed from one staff member to another and the politician is seldom available. Office visitation is possible with localized politicians but seldom is the constituent provided an audience. Larger urban areas frequently have an office representing state or national level politicians but seldom is the elected official available and again issues are dealt with by staff. A personal visit must be conducted during normal working hours and for most people that means time away from their job. Letters are time consuming, require locating the correct addresses and mailing. E-mail, is quick and easy but can involve time and some expertise in writing constructively.

The prior art also requires contacting each political entity representing a district individually (i.e. state and federal Congressman, state and federal Senator, Governor and President, etc.).

The prior art usually elicits a warm, immediate response and a declaration of action by the politician. Seldom does the constituent's communique receive a response after the politician has taken action on the issue because action occurs infrequently. Again, constituents must research to discover if legislative action has transpired and by whom.

From the politicians perspective, it can be difficult in the prior art to establish a majority position, within a voting district, on many issues because of the difficulty in accurately surveying constituents. Surveying every member of a voting district (large or small) on every issue is logistically and financially prohibitive. Usually, the politician is relegated to correspondence and input from the most politically active individuals, who also have non-typical amounts of available time and are therefore not necessarily a statistically accurate model of the district's population.

The methods of the prior art, with some frequency, do result in an undemocratic system where the few are represented over the majority.

The prior art allows for legislation to be introduced into a legislative environment, (i.e. Congress, Senate, House of Representatives etc.) by members of that body (i.e. Senators, Congressmen, Representatives, etc.). Legislative ideas can come from almost anywhere in society, from members themselves, constituents, special interest groups, business entities, petitioning, executive presentation (i.e. gubernatorial, Presidential) and others. Regardless of the origin, a member of the legislative body must introduce legislation. Petitioning may induce a member to introduce legislation but in most cases legislative introduction, or not, is based on the decision of the legislative member.

Large contributors, special interest groups, lobbyists and a variety of government offices and branches often have direct access to legislators. Constituents are relegated to access by secondary methods described above. The method and system for introduction of legislation by constituents in the prior art is prohibitively difficult.

Debate is the foundation of democratic government and largely the purpose of the buildings and physical structures containing legislative entities which provide shelter for the discussion, pros and cons, of any and all political issues by the members of those bodies. In the prior art, debate goes on among legislative members over every policy and issue effecting any and every fiber of society largely without direct input from the members of that society. Again, constituent input is based on the methods discussed above and many times, because of the limitations of the prior art, those opinions are not represented in legislative debate.

Posting surveys and voting venues on the Internet are widespread. Online political venues provide opportunities for voting on issues and opinions but not on active legislation. Many sites post political information, assist in voter registration, match voters to candidates, etc. but fail to present pending legislation in an online voting format where politicians performance is rated against constituency voting records.

Web site prior arts are concerned with Internet security in voting venues, posting of information and conducting surveys but not with active participation in legislative procedures by the public or rating corresponding actions of legislative Representatives.

In view of the prior art, there remains a need for politicians to be held accountable through a scoring system that directly relates their voting actions against the desires of their constituency and the need to greatly simplify constituency participation in the legislative process. The systems and methods of the prior arts rely on opinions and surveys not on pending legislation. Nor are the results of those methods used to evaluate political performance.

### SUMMARY AND OBJECTS OF THE INVENTION

The invention provides a web site system to present, but not limited to, proposed and active legislation, policies, cases and issues within political entities, in an online format for voting, proposing, blogging, providing input, etc. and a method to statistically evaluate and report data input by the users. The invention provides improvements over the prior art through direct constituent interaction, a performance scoring method that holds politicians accountable, helping to ensure majority representation in legislative procedures and reduction of wealth influence in the political process.

The first objective of the invention supports claim 1 and provides constituents within any voting district or system a method for voting on proposed legislation before it is voted on within the political body which provides Representatives with accurate and constant political guidance.

The invention is a system to report current activity, proposals, bills, resolutions etc. before a legislative body, in an online voting format where registered voters may vote on any or every issue confronting legislatures. Participating registered voters will register with the web site through a secure service making each member identifiable in the voting system to ensure a one-person one-vote system. Each registered voter may vote one time on each piece of legislation before it is voted on in the legislature, and the results are continuously updated and reported. Since results are available prior to the legal vote in the legislature, politicians have the ability to vote according to constituents' wishes on every piece of legislation. This system allows a method for statistical and accurate evaluation of political performance against constituents' wishes through a performance scoring method. Or simply put, a scoring system reflecting how well a politician is representing his people. Providing, useful, concrete and tangible results that improve the prior art.

The votes gathered through the system are broken down according to every voting district and the results from each district are available to the corresponding Representative, Senator and President (or other legislative bodies and members). After legal voting takes place within the legislative body and member votes are reported, each member's vote will be compared to the online votes of that politician's district and the politician will be scored according to how well he/she represented constituents. If a politician voted along the lines of his/her constituents that politician gets a positive score. If a politician votes against the wishes of his/her constituents, that politician gets a negative score. During a legislative session, every vote by every politician is continually compared against his/her constituencies voting record constantly updating their performance score. At sessions end, a final score is reported and accessible online.

For example: There is a bill in The United States Congress to change the color of the sky from blue to green. I am a constituent of the 1^{st} district of Alabama, and I went online and voted ‘yes’ to change the color of the sky from blue to green. A ‘yes’ vote would automatically be tallied for the House of Representative congressperson representing the 1^{st} district of Alabama, as would both Senators from the state of Alabama receive a ‘yes’ vote and the President of the United States would also receive a ‘yes’ vote.

Let's additionally say, that a majority of voters voted ‘yes’ from the 1^{st} district to change the color from blue to green, a majority of people from Alabama voted ‘yes’ but a majority of people from the US voted ‘no’.

If the congressperson representing the 1^{st} district of Alabama voted ‘no’ in the House of Representatives that person would get a −1 score because of voting against constituents wishes. If both Senators voted ‘yes’, to change the color, then they would both get +1 scores because they voted with the wishes of their constituents. If the President vetoes the bill and therefore votes ‘no’, then he/she would get a +1 for representing the wishes of the country. The votes are constantly tallied to keep a running score. If a Representative has a score of 50 after one hundred votes, then it is obvious he/she did not represent the wishes of the constituency because he/she went against them 25 times. If one of the Senators scores 100 after 100 votes, then he/she voted along the lines of the constituents on every vote and has a perfect score. (See DETAILED DESCRIPTION OF THE INVENTION paragraph [0066] below for greater explanation of the scoring system example above).

Using this system and method, voters may readily evaluate the need for a politicians continued representation in government at the next election. Providing, useful, concrete and tangible results that improve the prior art.

An objective of the invention supporting claim 2 is to provide a system and method to develop and present new legislation directly from a constituency and score political Representatives through a method of awarding or docking performance points based on their participation in introduction of proposed legislation.

The invention provides an online system where participants may create their own legislative ideas and post those ideas, for popular review, within legislation categories, i.e. health, economy, budget, homeland security, defense, education, etc. A registered voter may write his/her own legislation and post such legislation online for peer scrutiny and direct voting for or against the suggested legislation. Once users vote on posted legislation, a method is provided to tally those votes, post results and rank each legislative idea against similar legislation within each category. The most popular legislative pieces will be re-posted for petition collection where members can electronically sign the petition. The legislation piece receiving the most signatures will be sent to the legislative Representatives, representing the voting district from which the legislation originated, for introduction into the political law making process.

Once constituency sponsored legislation is received by the corresponding political Representative, he/she will be scored on their participation in introducing that legislation into the law making system.

For example: Voter Alice from Alabama's 1^{st} district posts a legislative suggestion freezing all congressional pay raises for ten years. Members using the invention vote the legislation to the top of the budget category and it also receives the most online petition signatures. The legislation and petition information is presented to the congressperson representing Alabama's House of Representatives 1^{st} district and both Alabama State Senators for introduction into the legislative process.

The congressperson, Representative Bob, introduces the legislation in the House of Representatives. The Senators have an opportunity to jointly submit the legislation in the senate. Senator Candice, introduces the legislation and Senator Two refuses signatory support. Under the invention's scoring method, Representative Bob of Alabama's 1^{st} district would receive five points added to his performance score for introducing constituent legislation, as would Senator Candice. Senator Two would have five points subtracted from his performance score for failing to present constituent legislation.

Based on the scoring system of the invention, constituents will have a method to determine the demand of a particular politician's future services. Providing, useful, concrete and tangible results that improve the prior art.

Claim 3 is supported by an objective of the invention that provides a system and method to educate not only youth but also any person interested in the democratic process, provide statistical information about youth and world opinions, and encourage democratic involvement.

To meet the above objectives, voting would not be restricted to legally registered voters. Non-registered voters such as those underage or non-citizens would also be allowed to vote but on an informational basis only. In other words, those non-registered votes would not count for or against politicians' representation scores. Those votes would be tallied and reported for informational purposes only, providing the statistical pulse of our youth and a survey of worldwide opinions. The non-registered voters' venue would also be a valuable educational tool, allowing youth and non-registered persons the opportunity to participate in and see the results of democratic involvement as well as encourage greater voter registration.

Students will have a method where they may learn democratic principals in school classrooms by allowing them to vote in the online system, see the results of their involvement, compare their involvement to the results of an actual legislative body and study voting statistics from all districts within a society.

Worldwide opinion is becoming increasingly important in most nations and their politics. This invention provides a place for politicians, newspersons or any interested party to find global voting statistics and/or opinions on issues facing governments around the world, including the United Nations. More importantly, many non-democratic governments do not allow public voting so there is no registration process for citizens. The invention serves the democratic needs of those individuals by providing them the exact same services as any democratic nation but without formal voter registration with their government. Whether governments choose to participate and serve constituent needs as determined through the invention would of course remain up to those governments. However, the invention provides a place for the democratic seed to be planted and change societies from within.

Providing an online legislation participation web site which also posts the results of student and non-citizen participation, will encourage more persons to get registered and vote in legal elections as well as participate in online representation activities. By serving the democratic needs of individuals in nations that have no formal voting process, the invention may encourage political change in politically repressive countries. Providing, useful, concrete and tangible results that improve the prior art.

An objective of the invention supporting claims 1 through 3 is to provide a democratic voice to societies without democratic representation around the world while broadening the scope of democratic representation in all societies.

Citizens of non-democratic governments frequently have no social identity or consciousness due to the fact that group ideas and expression are often stifled, resulting in populace control. Democracies are not only based on, but also formed by, information sharing and the energy fueled from social consciousness. The invention breaks down the subjugation of governments engaging in societal-control methods by providing members of any political system, a site on the world wide web not only to vote on issues facing their governments but a place to develop their own popular legislation, collect ideas, join and create political groups and promote action. It will also allow politicians within those restrictive governments a place to determine the needs of their populace, provide civil means of change and/or better representation. Providing, useful, concrete and tangible results that improve the prior art.

Another objective supporting claims 1 though 3 is to increase majority constituent representation in the political process while decreasing minority influence of government.

The invention provides a system and method for voters to cull politicians who do not abide by the concept of democratic principals when they fail to vote along the lines of the majority. The scoring method of the invention will allow quick and easy evaluation of a politician's voting behavior, providing the voting populace with the ability to vote in an educated manner. Politicians who represent interest groups' desires over the wishes of the constituency will most likely be voted out of office in the following election. The system provides a method to meet the objective of making government more accurately democratic in its service to the populace, providing, useful, concrete and tangible results that improve the prior art.

### BRIEF DESCRIPTION OF THE SEVERAL VIEWS OF THE DRAWING

The drawings, brief and detailed descriptions assist in understanding the invention but are not meant to limit the scope or uses of the invention.

FIG. 1 illustrates an overview of information flow.

FIG. 2 illustrates the flow of constituent and politician voting.

FIG. 3 illustrates the educational and informational uses of the invention.

### DETAILED DESCRIPTION OF THE INVENTION

The invention broadens the individual's Representative powers in virtually any government or political system on earth through web site applications posted on the World Wide Web. Any person, group, association, union, corporation, government, political entity or other bodies with access to the World Wide Web may benefit from use of the invention.

Although the following discussion concentrates on the functions of the United States federal government, as an example, the present invention may be applied to any group creating, posting or volunteering information on the World Wide Web that may be used to seek majority constituent representation and/or non-constituent opinion. The FIGURES presented, detail working aspects of the invention so that any person of ordinary skill in the art and science could readily produce and use the invention. However, neither the drawings, any segment of the invention description, nor the invention details, are intended to limit the invention by those illustrations or explanations.

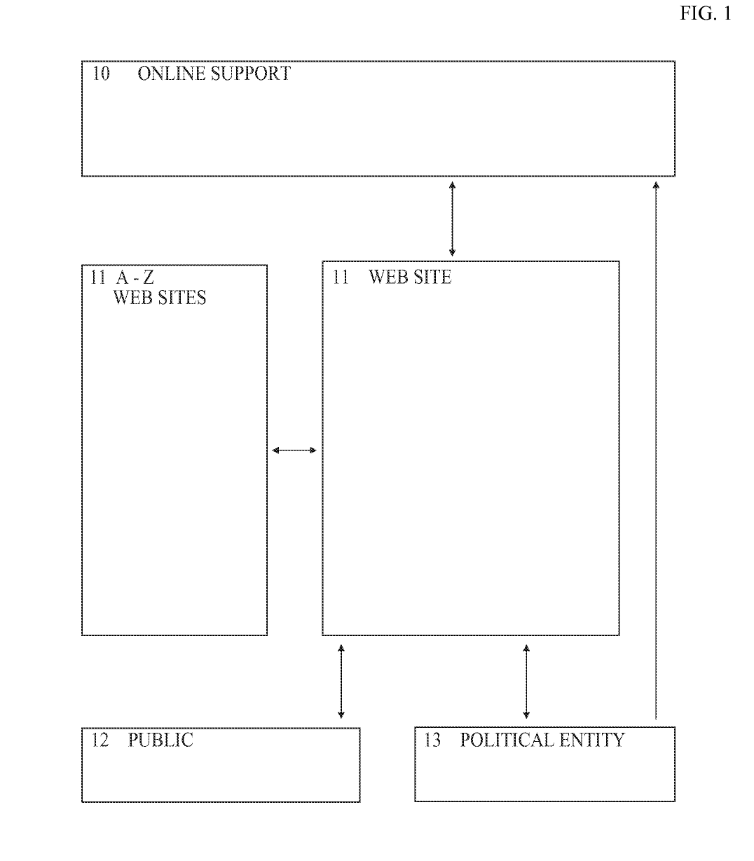

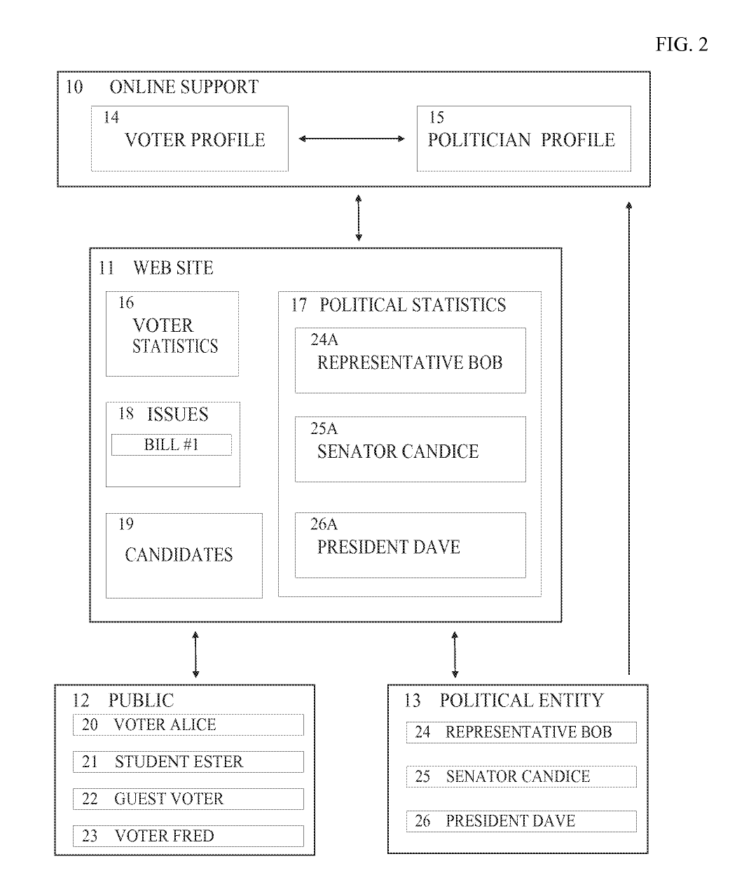

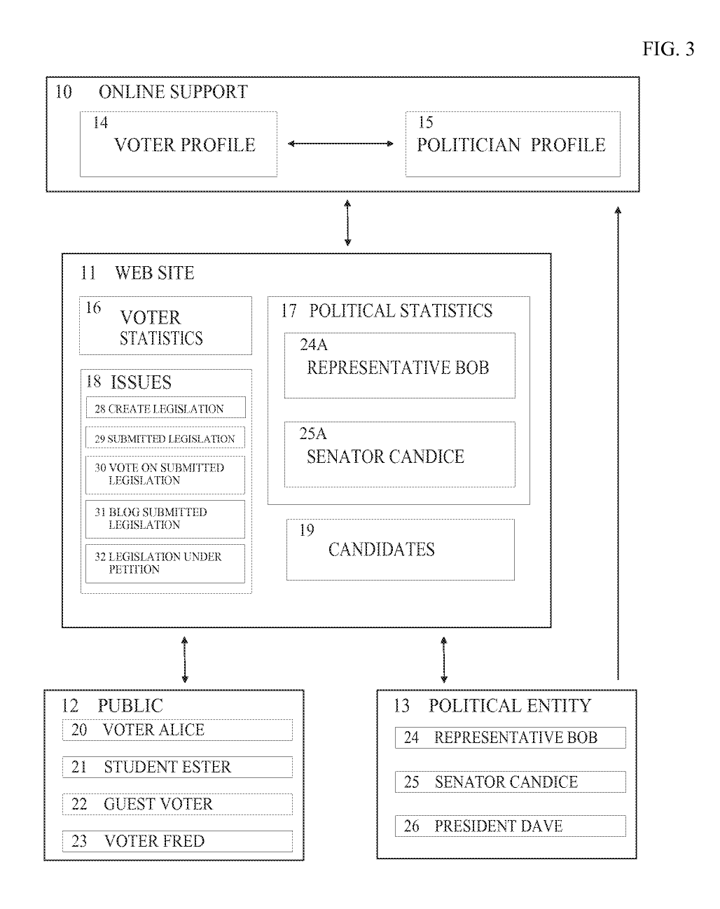

FIG. 1 generally relates how legislation is posted on the web site, viewing of legislation by the public, voting on legislation by the public, matching of constituents online votes to politician's legislative votes and viewing of results. FIG. 2 through FIG. 3 may be used in conjunction with FIG. 1 and provide specific details of the claims.

In the example of, but not limiting the scope of the invention to, the United States Congress, all legislation introduced in that system must be posted online in the Thomas Register. Both the House of Representatives and Senate post active legislation and voting records as well. The White House and Supreme Court also post active legislation and cases online. Political and legislative information may be retrieved from any and/or all of these sources.

FIG. 1 illustrates that Online Support 10 services Web Site 11 and retrieves political information from Political Entity 13. The online support center provides security for the web site and the data center and protects personal data from intrusion, theft and attacks. The drawing also demonstrates that legislation retrieved by Online Support 10 is posted on Web Site 11. Online Support 10 also retrieves each politician's profile from Political Entity 13 and stores that data. Individuals from Public 12 may visit Web Site 11 and choose to vote on legislation or political events. Those participating fill out a secure profile and it is securely stored by Online Support 10. Once an individual from Public 12, views an issue on the Web Site 11, and votes on that issue, the voter's profile information is matched to each politician representing that person's voting district by Online Support 10 and delivers the vote to each of those politicians' profiles. The politician can then retrieve all their constituent data from Web Site 11 and make an informed voting decision on each issue they face in a legislative body. Members from Public 12 may go to Web Site 11 and choose to receive e-mail alerts about active issues, upcoming events, elections, politicians, candidates, etc.

Voter eligibility is determined by Online Support 10 and members who are legally registered voters may vote accordingly on posted legislation and events. Non-registered voters from Public 12 may also vote but their vote counts as non-registered voters and their statistics are not counted for or against any politician.

The invention may serve the public in any society on earth. As seen in FIG. 1 any person on earth from Public 12 with World Wide Web access may sign onto Web Site 11. On the opening page of Web Site 11, they have the option of choosing a country from the menu. When an individual clicks on the country desired, they are taken to the web site designed to service that country and represented by Web Sites 11 A-Z in FIG. 1. The site is presented in the national language of that country. A person from Spain would click on Spain on the opening page country menu on Web Site 11 and he/she would be taken to Web Sites 11 A-Z (representing Spain in this example). Where Web Sites A-Z function just like Web Site 11, only in Spanish and dealing with the issues and politics of Spain.

The following 11 paragraphs primarily support claim 1. FIG. 2 displays the flow of constituent voting, statistical reporting and delivery to appropriate politicians. In FIG. 2, a constituent from Alabama's 1^{st} district, Voter Alice 20, from Public 12 signs onto Web Site 11 and fills out a secure and confidential voter profile to become a voting member of the invention. Her confidential voting profile is permanently stored by Online Support 10 in Voter Profile 14 for future identification. Voter Alice 20 clicks on Issues 18 in Web Site 11 and discovers Bill #1 is of interest to her. Voter Alice submits a ‘yes’ vote for Bill #1. The vote from Voter Alice 20 goes to Voter Profile 14 in Online Support 10. Her voting eligibility is determined from her profile and the Voter Alice 20 profile is compared to profiles kept on politicians in Politician Profile 15. Online Support 10 determines that Voter Alice 20 is represented by, Representative Bob 24, Senator Candice 25 and President Dave 26. On-line Support 10 sends the ‘yes’ vote for Bill #1, back to Web Site 11 for display in Voter Statistics 16, and Political Statistics 17 where votes are distributed to Representative Bob 24A, Senator Candice 25A and President Dave 26A.

Since Representative Bob 24, is the only Representative for Alabama's 1^{st} district, he is the only Representative in the United States House of Representatives who will receive a ‘yes’ vote for Bill #1 from Voter Alice 20 in his online profile Representative Bob 24A. Representative Bob 24A would also receive all votes, ‘yes’ and ‘no’ on Bill #1, from all votes cast from Alabama's 1^{st} district. But Representative Bob 24A would not receive any votes from any other voting district in the United States.

There are two Senators representing Alabama in the US Senate so both Senator Candice 25A and the other Alabama Senator (not represented in the diagram) would receive ‘yes’ votes on Bill #1 from Voter Alice 20 in their online profiles located in Political Statistics 17. Both Senators would also receive all votes, ‘yes’ and ‘no’ on Bill #1, from all votes originating from Alabama but not from any other state.

President Dave 26 represents the entire nation so he would receive a ‘yes’ vote from Voter Alice 20 in his online profile, President Dave 26A. President Dave 26A would also receive every vote, ‘yes’ and ‘no’ on Bill #1, from every participating voter in the United States.

From Public 12, any person such as Voter Alice 20 may go online to Web Site 11 and review macro voting statistics kept on each bill (such as Bill #1), issue, candidate, etc, in Voter Statistics 16 as well as check out micro voting statistics kept on each politician in Political Statistics 17. Politicians may go online to Web Site 11 and view all voting statistics as well. Senator Candice 25 may go online to Web Site 11, look in Political Statistics 17 and view her profile, Senator Candice 25A, where every vote cast from Alabama on Bill #1 is tallied. She can then see how to best represent her constituents on Bill #1 when that bill arrives on the Senate floor for discussion and voting.

Likewise, President Dave 26 may go online to Political Statistics 17, then to President Dave 26A and see a tally of all votes posted in the United States on Bill #1. He will then know how to best represent the wishes of the people of the US on whether to veto Bill #1 or sign it into law.

FIG. 2 also illustrates the flow of politicians' legal votes in the system, how they are compared to constituent votes, scored and the reporting method. When a member of the Political Entity 13 casts a legal vote on Bill #1 in their respective legislative body, that vote information is retrieved from Political Entity 13 by Online Support 10 and stored in Politician Profile 15. That politician's vote is compared to Voter Profile 14 statistics on Bill #1 and a score is determined representing how accurately that politician represented his/her constituents. If the politician voted with his constituents' majority opinion on Bill #1, then he gets a positive score. If the politician voted against his constituents' majority opinion on Bill #1, then he gets a negative score. Online Support 10 posts the resulting score for Bill #1 in that politician's profile in Political Statistics 17 and either adds or subtracts that score from Bill #1 to his/her total performance score.

Example: Representative Bob 24 casts a ‘yes’ vote for Bill #1 and Online Support 10 retrieves his vote, stores it in Politician Profile 15 and it is compared against his constituents' voting statistics for Bill #1 in Voter Profile 14. Online Support determines Representative Bob voted according to the majority of his constituents, he is awarded 1 point and that point is added to his performance score in Representative Bob 24A located in Political Statistics 17 on Web Site 11. His score prior to voting on Bill #1 was 78, one point is added for voting with constituent wishes, and the new cumulative performance score is 79 points.

Example: Senator Candice 25 casts a ‘no’ vote for Bill #1 and Online Support 10 retrieves her vote, stores it in Politician Profile 15 and compares it against her constituents' voting statistics for Bill #1 in Voter Profile 14. Online Support determines she voted against the majority of her constituents, she is docked 1 point and that point is subtracted from her performance score in Senator Candice 25A. Senator Candice had a performance score of 90 before voting on Bill #1. She voted against her constituents wishes so one point is subtracted and her new cumulative performance score is 89.

After members of Political Entity 13 have cast their legal votes on Bill #1, Voter Alice 20 may go online to Web Site 11 and review the profile in Political Statistics 17 of every politician representing her, to identify how well she and fellow constituents were represented by their politicians.

As mentioned above in SUMMARY AND OBJECTIVES, votes are constantly tallied to keep a running score. If a politician voted one hundred times and voted with his/her constituency seventy-five times he/she would receive 75 points toward his/her performance score. The politician voted against constituents twenty-five times so he/she has 25 points deducted from his/her performance score. The politicians performance score would reflect the total of 75 positive points and 25 negative points for a performance score total of 50. If a Representative has a score of 50 after one hundred votes then he/she did not represent the wishes of the constituency very well because he/she went against them twenty-five times. If one of the Senators scores 100 after one hundred votes then he/she voted along the lines of the constituents on every vote and has a perfect score.

The following 4 paragraphs support claim 2. FIG. 3 illustrates the invention's method for creating constituent legislation and scoring politicians on their introduction of that legislation. New legislation will be created directly from constituents, and may be introduced by legislators. Legislators performance scores will reflect their participation in the bill sponsorship program.

Example: Voter Alice 20 lives in Birmingham, Ala. and she is flying home from Boston, Mass. Upon arrival at the airport, she finds her flight has been canceled and she must wait until another flight with open seats becomes available. The airline refuses to compliment her ticket or reimburse her in any way. Fed up with airline abuse, Voter Alice 20 from Public 12 goes to Issues 18 on Web Site 11 and signs onto Create Legislation 28. She proposes a new law detailing airline passenger rights, a justification for the law and posts the submission under Submitted Legislation 29 in Issues 18. Anyone from Public 12 may sign onto Web Site 11, Issues 18, Submitted Legislation 29 and review all submitted legislation or search for legislation according to category.

Voter Fred 23 has a similar airline experience so he signs onto Issues 18 with the intention of creating an airline bill of rights but finds Voter Alice 20 has already posted legislation. After reading her submission, Voter Fred 23 has a choice, either go to Vote on Submitted Legislation 30 and vote ‘yes’ or ‘no’, or he can click on Blog Submitted Legislation 31. Voter Fred 23 decides that although Voter Alice 20 has suggested legislation requiring airlines that reassign passengers to alternate flights must reimburse passengers, he wants reimbursement to include excessive delays and goes to Blog Submitted Legislation 31 where he blogs her legislation seeking support for his amendment. There is much support in the blogging venue for Voter Fred 23's amendment so Voter Alice 20 amends her legislation to include Voter Fred 23's suggestion and resubmits it for consideration.

Voters from Public 12 see the legislation and place votes for and against it in the Vote On Submitted Legislation 30 forum. Voter Alice 20's legislation passes the online voting venue conducted in the Vote On Submitted Legislation 30 area. It is one of the most active pieces of suggested legislation, so it is moved up to collect signatures in Legislation Under Petition 32. In the Legislation Under Petition 32 venue, registered voters may electronically sign the petition. After 1000 signatures are collected, Voter Alice 20's legislation is sent to Voter Profile 14 and matched with politician's profiles stored in Politician Profile 15 that represent her voting district. The legislation is then sent to Voter Statistics 16 where anyone from Public 12 may view the results. The legislation along with petition signatures is posted on corresponding elected officials' profiles listed in Political Statistics 17. In this case, her Representatives are Representative Bob 24A, Senator Candice 25A and the unnamed Alabama Senator. Her Representatives are then awarded performance points for submitting her legislation or docked performance points for failing to act on the petitioned legislation.

Representative Bob 24 introduces the legislation in the House of Representatives and Senator Candice 25 proposes it in the Senate so both are awarded 5 bonus performance points. Alabama's other unnamed Senator refuses to co-sponsor the bill with Senator Candice so he has 5 points subtracted from his performance score.

The following seven paragraphs primarily support claim 3. FIG. 2 also illustrates the invention as an educational tool. Example: A 5^{th} grade classroom in Alabama's 1^{st} district is studying US government. The teacher has her students sign onto Web Site 11 from Public 12 and participate as voters, but without the scoring implications of a registered voter. The 5^{th} grader, Student Ester 21, fills out a voter profile on Web Site 11, views Bill #1 in Issues 18 and votes ‘no’. Student Ester 21's vote is sent to Voter Profile 14 in Online Support 10 where it is determined from her profile that she is too young to be a registered voter. But instead of denying Voter Ester 21 the opportunity to vote, she is allowed to participate as a youth-voter. Her vote is sent to Voter Statistics 16 and Political Statistics 17 where it is distributed to all the politicians representing her district just as they were for Voter Alice 20 above.

However, Student Ester 21's vote will be listed as a youth vote for Bill #1 in Voter Statistics 16, Political Statistics 17 and the corresponding politician statistics but not counted for or against any politician's performance score. Student Ester 21 and her classroom may not directly affect the voting habits of any politician but those students may view their votes tallied in a legitimate voting platform and determine how well they were represented. Likewise politicians, while not held accountable for the youth vote, may at least get a feel for the opinions of young residents living in their voting district.

FIG. 2 also illustrates the invention as a tool for gathering opinions from non-registered voters as well as global opinions. Any person from Public 12 may sign onto Web Site 11, register as a guest voter and participate in the invention's democratic process for any political entity represented on the site.

Example: Guest Voter 22 from Public 12 may be a legal US immigrant and resident, from Argentina, who wishes to learn the US democratic system as part of the naturalization process. Guest Voter 22 may go online to Web Site 11 and register to vote on the invention. The profile of Guest Voter 22 is sent to Online Support 10 where the profile is stored in Voter Profile 14. When Guest Voter 22 goes online and views Issues 18 where he/she sees Bill #1 in the US congress and votes ‘yes’ on the bill. Like any other vote, this vote is sent to Online Support 10 and registered in Voter Profile 14 where it is determined the vote is from a voter ineligible to legally vote in the US election system. Rather than discard the vote, the invention will list Guest Voter 22's vote as a guest voter and send the vote to Voter Statistics 16 and Political Statistics 17 where it is distributed to corresponding politicians representing the district from where the vote originated. Although the guest vote is not counted for or against any politician's performance score it is a valuable tool for gauging immigrant and/or world opinion.

While ineligible to vote legally in the US political process, Guest Voter 22 is a citizen and registered voter of Argentina. Guest Voter 22 may go to Web Site 11, click on Argentina in the countries menu and she is sent to Web Site 11 A-Z (as seen in FIG. 1) which represents Argentina in this case. Guest Voter 22 may then search in Issues 18 (as seen in FIG. 2), the issues displayed are Argentine issues so he/she may then vote in his/her country of origin as a registered voter and influence the performance score of his/her political Representatives.

Example: Guest Voter 22 may be a British citizen living in Britain and concerned about environmental issues in US politics. The British citizen Guest Voter 22 is already a voting member of Web Site 11 A-Z (as seen in FIG. 1) and actively participates as a registered voter in British politics. However, Guest Voter 22 goes to Web Site 11, clicks on United States, searches in Issues 18 for US environmental legislation and discovers Bill #1. Since Guest Voter 22 is already registered with the invention, his vote is sent directly to Voter Profile 14 in Online Support 10. Online Support 10 determines that he is not eligible to vote as a registered voter in the United States, but again, rather than discard the vote, it is sent to Voter Statistics 16 and tallied as a guest vote on US Congressional Bill #1. US politicians can then view global opinion quickly and easily when creating foreign policy or for information sake. The invention allows voters of any citizenship to voice opinions through a voting venue about the policies of any government on earth. It also allows any person of any citizenship to participate in his or her own political process or create voting venues for their society should that society deny those rights.

The guest vote not only allows non-registered voters, immigrants and foreigners a chance to experience the democratic process, it provides politicians a source for viewing global opinion. The statistical resources available from Issues 18 also provide valuable data for reporters, news agencies, political parties, candidates, etc. collecting political polling data.

Claims 1 through 3 are supported by FIG. 1 through 3. Application of the World Wide Web structure allows participation in the invention by any individual in any society. Even though a society may not offer political participation to its members through voting opportunities, the invention provides those members with a platform to generate legislation, vote on current legislation and evaluate leadership. Since the invention is based on the World Wide Web, it may be used by any person with or without the approval of their government. The invention provides a platform to create change, individual representation and democratic principals on a global level.

The invention incorporates web site and Internet technology and incorporates a variety of the hardware and software familiar to the industry. Servers, networks, routers, terminals, computers of a variety of embodiments and components that constitute the creation, posting, distribution and viewing of a web site over the World Wide Web are used. Software for computer programming, web design, surveying, statistical analysis, media, and database structures are used in the invention. All components of the invention, hardware and software are widely available on the market in a multitude of forms and from a variety of manufactures. A person familiar with the art and science should have the ability to reproduce and use the invention with the descriptions and drawings provided without difficulty.

I claim:

1. A system for presenting active legislation, facing a political body, in an online format where constituents may vote on legislation prior to political Representatives of that body casting their legal votes and reporting corresponding data and statistics; from which a method for scoring politicians performance is calculated and reported, based on comparing their voting record to the online voting results of their constituency.

2. A system providing online development of legislation for introduction into a political system, reporting of such legislation along with data and statistics from which a method of scoring politicians based on their participation in introducing legislation developed online by their constituency is reported.

3. A system where youth and non-registered voters may participate in the online voting process of claim 1 and claim 2, for educational and informational purposes and report corresponding data and statistics.
